(19) United States
(12) Patent Application Publication
(10) Pub. No.: US 2026/0203983 A1
(43) Pub. Date: Jul. 16, 2026

(54) REAL-TIME AUDIO-BASED FULL-BODY GESTURE GENERATION FOR 3D AVATAR

(71) Applicant: Samsung Electronics Co., Ltd., Suwon-si (KR)

(72) Inventors: Byeonghee Yu, Berkeley, CA (US); Danke Xie, San Jose, CA (US); Srinivasa Reddy Algubelli, Mountain House, CA (US); Siva Penke, San Jose, CA (US)

(21) Appl. No.: 19/175,966

(22) Filed: Apr. 10, 2025

Related U.S. Application Data
(60) Provisional application No. 63/745,729, filed on Jan. 15, 2025.

(51) Int. Cl. G06T 13/20; G06T 13/40

(52) U.S. Cl. CPC G06T 13/205; G06T 13/40

(57) ABSTRACT

To generate three-dimensional (3D) avatar animation in real-time based on an audio stream, sequential portions of the audio stream are buffered within each of the audio buffers. For audio content in each audio buffer: Speech features are extracted from the audio content using an audio encoder. The extracted speech features are provided as input to a gesture generation model trained to predict 3D position of the body's center and orientation of all body joints in a head or a head and body of the speaker. Based on the predicted 3D position of the body's center and orientation of all body joints, final 3D animation keyframes are generated for gestures by an avatar for the speaker. The extracted speech features and the final 3D animation gesture keyframes for the avatar are stored in a memory. Audio corresponding to the audio content in the audio buffer is played synchronously with presentation of the final 3D animation keyframes of gestures by the avatar.

### CROSS-REFERENCE TO RELATED AND CLAIM OF PRIORITY

This application claims priority under 35 U.S.C. § 119(e) to U.S. Provisional Patent Application No 63/745,729 filed on Jan. 15, 2025, which is hereby incorporated by reference in its entirety.

### TECHNICAL FIELD

This disclosure relates generally to animating avatars for real-world users. More specifically, this disclosure relates to real-time audio-based full-body gesture generation for a three-dimensional (3D) avatar.

### BACKGROUND

Market trends suggest the desirability of an on-device, conversational, three-dimensional (3D) artificial intelligence (AI) avatar, especially when combined with on-device large language models (LLMs). This avatar can be driven by not only the user's voice but also output from an LLM converted to a synthetic voice. However, despite a recent rise of on-device LLMs, most avatar animation technologies are limited to facial animation, and body gesture generation technologies mostly remain as non-real time solutions. Adding full-body gestures to a 3D avatar makes the avatar significantly more realistic and captivating for users.

### SUMMARY

This disclosure relates to real-time audio-based full-body gesture generation for a three-dimensional (3D) avatar.

In a first embodiment, a method of generating 3D avatar animation in real-time based on an audio stream includes buffering sequential portions of the audio stream within each of a plurality of audio buffers. The method also includes, for audio content in each of the plurality of audio buffers, extracting speech features from the audio content in the audio buffer using an audio encoder; providing the extracted speech features as an input to an on-device gesture generation model trained to predict 3D position of the body's center (root) and orientation of all body joints in at least one of (i) only a head of a speaker or (ii) a head and body of the speaker; generating, based on the predicted 3D position of the body's center (root) and orientation of all body joints, final 3D animation keyframes of gestures by an avatar for the speaker; storing the extracted speech features and the final 3D animation keyframes of gestures by the avatar in at least one memory; and playing audio corresponding to the audio content in the audio buffer and synchronously presenting the final 3D animation keyframes of gestures by the avatar to a viewer.

In a second embodiment, an electronic device for generating 3D avatar animation in real-time based on an audio stream includes at least one processing device. The at least one processing device is configured to buffer sequential portions of the audio stream within each of a plurality of audio buffers. The at least one processing device is also configured, for audio content in each of the plurality of audio buffers, to extract speech features from the audio content in the audio buffer using an audio encoder; provide the extracted speech features as an input to an on-device gesture generation model trained to predict 3D position of the body's center (root) and orientation of all body joints in at least one of (i) only a head of a speaker or (ii) a head and body of the speaker; generate, based on the predicted 3D position of the body's center (root) and orientation of all body joints, final 3D animation keyframes of gestures by an avatar for the speaker; store the extracted speech features and the final 3D animation keyframes of gestures by the avatar in at least one memory; and play audio corresponding to the audio content in the audio buffer and synchronously present the final 3D animation keyframes of gestures by the avatar to a viewer.

In a third embodiment, a non-transitory machine readable medium contains instructions that when executed cause at least one processor of an electronic device to buffer sequential portions of an audio stream within each of a plurality of audio buffers. The non-transitory machine readable medium also contains instructions that when executed cause the at least one processor, for audio content in each of the plurality of audio buffers, to extract speech features from the audio content in the audio buffer using an audio encoder; provide the extracted speech features as an input to an on-device gesture generation model trained to predict 3D position of the body's center (root) and orientation of all body joints in at least one of (i) only a head of a speaker or (ii) a head and body of the speaker; based on the predicted 3D position of the body's center (root) and orientation of all body joints, generate final 3D animation keyframes of gestures by an avatar for the speaker; store the extracted speech features and the final 3D animation keyframes of gestures by the avatar in at least one memory; and play audio corresponding to the audio content in the audio buffer and synchronously present the final 3D animation keyframes of gestures by the avatar to a viewer.

Any single one or any combination of the following features may be used with the first, second, or third embodiment. Processing of the audio content in a specified one of the audio buffers may be completed before the audio corresponding to the audio content in a preceding one of the audio buffers is fully played and the corresponding final 3D animation keyframes of the avatar is synchronously presented to the viewer. Extracted speech features and final 3D animation keyframes may be continuously updated for a fixed number of the plurality of audio buffers stored to maintain a context, and the extracted speech features may be provided from the at least one memory to the gesture generation model as context. An avatar mode selection may be received from a user, where a first avatar mode corresponds to 3D avatar animation for only the head of the speaker and a second avatar mode corresponds to 3D avatar animation for the head and body of the speaker. A motion blending mode selection may be received from a user, where (i) motion blending may be enabled in a first motion blending mode with the predicted raw animation keyframes blended with predetermined animations and (ii) motion blending may be disabled in a second blending mode with the predicted raw animation keyframes directly used. The 3D avatar animation may be generated in the first avatar mode and the first motion blending mode by predicting the raw head animation keyframes, constraining rotation axes to control head motion types, and either blending the raw head animation keyframes with predetermined body animation or applying body movement in synchronization with head motion for the 3D avatar animation for only the upper body. The 3D avatar animation may be generated in the first avatar mode and the second motion blending mode by predicting the raw head animation keyframes. The 3D avatar animation may be generated in the second avatar mode and the first motion blending mode by predicting the raw upper body animation keyframes and body positions and blending the raw upper body animation keyframes with predetermined lower body animations and/or finger motions in a synchronized manner that aligns with the predicted body positions. The 3D avatar animation may be generated in the second avatar mode and the second motion blending mode by either predicting the raw upper body animation keyframes and body positions or predicting the raw full body animation keyframes and body positions. The raw upper body animation keyframes may be blended with the predetermined lower body animations and finger motions by synchronizing motion intensity of the predetermined animation with pitch and intensity of the audio corresponding to the audio content in the audio buffer and with the predicted body positions. The motion intensity of body animation may be synchronized with the pitch and intensity of the audio by creating at least one configuration file based on input audio features and predicted body keyframes, setting parameters in the at least one configuration file controlling motion intensity of the predetermined lower body animations and selection of active or subtle finger gestures, and combining the raw upper body animation keyframes with the predetermined lower body animations and finger motions according to the motion intensity and the selection of active or subtle finger gestures. The gesture generation model may be configured to predict encoded avatar motion from the speech features, receive the encoded avatar motion to generate raw 3D avatar animation keyframes, and condition motion generation based on a gesture style input allowing user control over a style of hand motions. The final 3D animation keyframes of gestures by the avatar for the speaker may be generated by applying a smoothing filter across motion sequences including prior 3D animation keyframes from the at least one memory and correcting one or more sliding feet artifacts of a lower body of the avatar. The on-device gesture generation model may be deployed on at least one of: a mobile device, an extended reality (XR) device, or a robot. The audio corresponding to the audio content in a specified one of the audio buffers may be the audio content in the specified one of the audio buffers that is directly played for the viewer or audio generated by a text-to-speech model for the audio content in the specified one of the audio buffers.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed during real-time full-body gesture generation for a 3D avatar in accordance with this disclosure;

FIG. 2 illustrates an example process of real-time gesture generation for a three-dimensional (3D) avatar in accordance with this disclosure;

FIG. 3 illustrates an example dynamic selection process by a user among modes of avatar body expressions for purposes of real-time gesture generation in accordance with this disclosure;

FIG. 4 illustrates an example architecture for providing real-time audio-based gesture generation in accordance with this disclosure;

FIG. 5 illustrates an example model preparation system for an artificial intelligence (AI)-based model providing real-time audio-based gesture generation in accordance with this disclosure;

FIG. 6 illustrates an example pipeline for AI-based provision of real-time audio-based full-body gesture generation in accordance with this disclosure;

FIGS. 7A and 7B illustrate an example processing of audio buffers of any length in real-time audio buffers of any length during AI-based provision of real-time audio-based gesture generation in accordance with this disclosure;

FIG. 8 illustrates example motion autoencoder training and audio-motion mapping for AI-based provision of real-time audio-based gesture generation in accordance with this disclosure;

FIG. 9 illustrates example model inferencing for AI-based provision of real-time audio-based gesture generation in accordance with this disclosure;

FIGS. 10A through 10C illustrate example post-processing for different modes of body expression during AI-based provision of real-time audio-based gesture generation in accordance with this disclosure;

FIG. 11 illustrates example operation of a motion intensity synchronizer of FIG. 10C for lower body motion in accordance with this disclosure;

FIGS. 12 and 13 illustrate example operation of the motion intensity synchronizer of FIG. 10C for finger motion in accordance with this disclosure; and

FIG. 14 illustrates example use cases for AI-based provision of real-time audio-based gesture generation in accordance with this disclosure.

### DETAILED DESCRIPTION

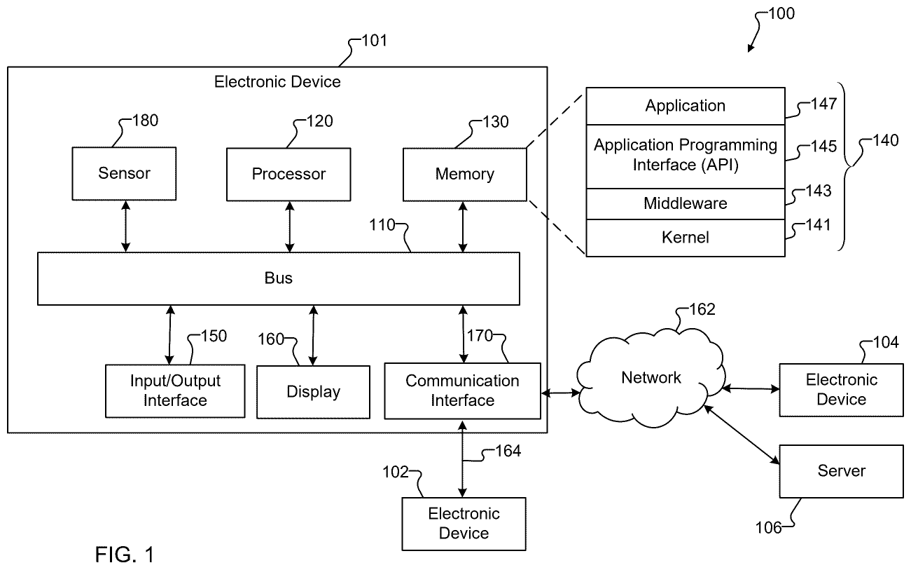

FIGS. 1 through 14, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, market trends suggest the desirability of an on-device, conversational, three-dimensional (3D) artificial intelligence (AI) avatar. However, most avatar animation technologies are limited to facial animation, and body gesture generation technologies remain non-real time solutions. For example, a user filming a video or participating in video conferencing may wish to employ an avatar for the video portion of the content, and the avatar may need to be animated to be engaging for an observer. Animation of an avatar, however, should coordinate the avatar's gestures (such as the user's head and upper body movement, full body movement, and/or hand or finger gestures) with corresponding audio content. Moreover, the gestures should be generated in real-time with the audio input. This disclosure provides various techniques to achieve this.

FIG. 1 illustrates an example network configuration 100 that may be employed during real-time full-body gesture generation for a 3D avatar in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to real-time gesture generation for a 3D avatar.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to real-time gesture generation for a 3D avatar. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232(RS- 232 ), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or an extended reality (XR) headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the electronic device 101 and/or the server 106 may perform various operations related to real-time gesture generation for a 3D avatar. For example, the electronic device 101 may be employed to consume content, while the server 106 may be employed to define preset gestures for use during real-time gesture generation for a 3D avatar on the electronic device 101.

Although FIG. 1 illustrates one example of a network configuration 100 including an electronic device 101 employed during real-time gesture generation for a 3D avatar, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

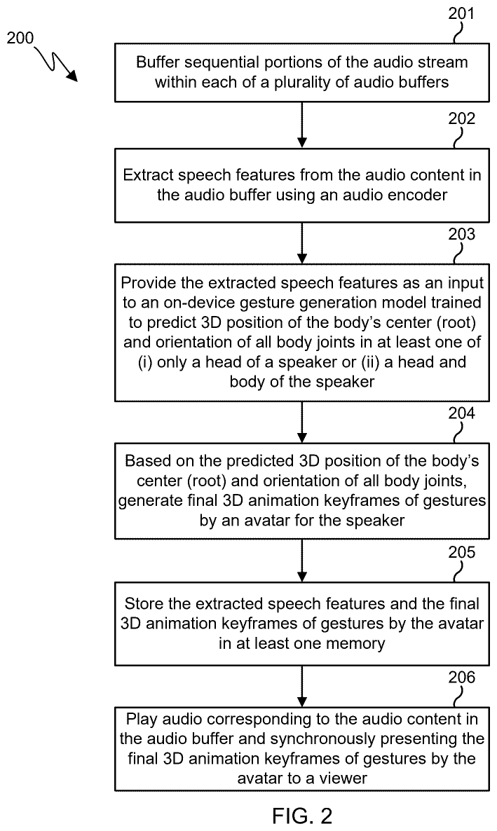

FIG. 2 illustrates an example process 200 of real-time gesture generation for a 3D avatar in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 includes buffering sequential portions of an audio stream within each of a plurality of audio buffers (step 201). While animation may be generated only for the current audio buffer, past and future audio buffers may be employed for audio context. In some cases, the size of the audio buffers need not correspond to the duration of animation frames for an avatar.

For audio content in each of the plurality of audio buffers, speech features are extracted from the audio content in the audio buffer using an audio encoder (step 202), and the extracted speech features are provided as input to an on-device gesture generation model (step 203). The gesture generation model can be trained to predict 3D position of the body's center (root) and orientation of all body joints in at least one of (i) only a head of a speaker or (ii) a head and body of the speaker. The “body” of the speaker may include the speaker's upper torso or the speaker's entire body covering the torso, hips, and legs. Based on the predicted 3D position of the body's center (root) and orientation of all body joints, final 3D animation keyframes of gestures by an avatar for the speaker are generated (step 204). The gestures may involve head-only motion, head plus upper body motion, head plus full body motion, head plus full body including finger motion, etc.

The extracted speech features and the final 3D animation keyframes of gestures by the avatar are stored in at least one memory together with the audio input (step 205). Audio and/or animation keyframes for past and future audio buffers may be accessed from the memory for audio and/or motion context in either gesture generation or post-processing. Audio corresponding to the audio content in the audio buffer is played synchronously with presentation of the final 3D animation keyframes of gestures by the avatar to a viewer (step 206). The audio played during the presentation of the animated avatar with the generated gestures may be the content in the current audio buffer directly played for the viewer or audio synthesized by a text-to-speech model.

Although FIG. 2 illustrates one example of a process 200 of real-time gesture generation for a 3D avatar, various changes may be made to FIG. 2. For example, while shown as a series of steps, various steps in FIG. 2 could overlap, occur in parallel, occur in a different order, or occur any number of times (including zero times).

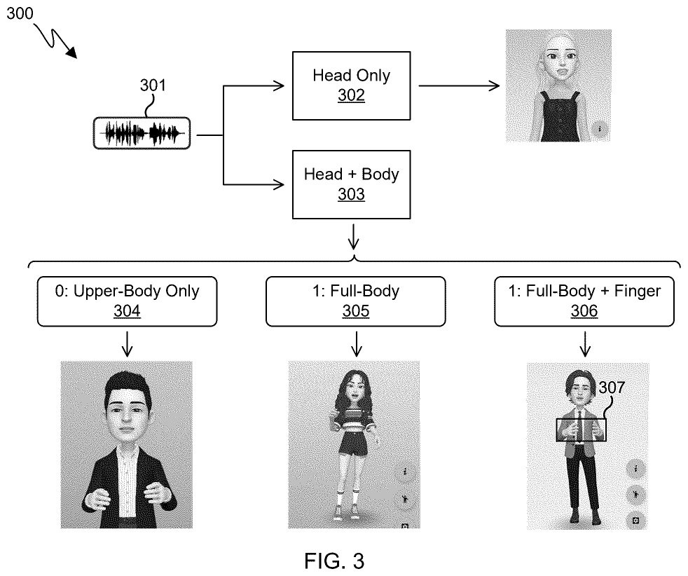

FIG. 3 illustrates an example dynamic selection process 300 by a user among modes of avatar body expressions for purposes of real-time gesture generation in accordance with this disclosure. For ease of explanation, the dynamic selection process 300 of FIG. 3 is described as being implemented within the electronic device 101 in the network configuration 100 of FIG. 1, optionally in part by operating interactively with the server 106. For example, the electronic device 101 in some embodiments described below may represent an HMD that implements the dynamic selection process 300. However, the dynamic selection process 300 may be implemented using any other suitable device(s) and in any other suitable system(s).

One example aspect of this disclosure involves providing an end-to-end real-time (optionally full-body) gesture generation machine learning (ML) model, along with state machine-based configurable lower-body and finger motions. As part of the dynamic selection process 300, a live audio stream 301 is received. The live audio stream 301 may be buffered as described in further detail below. Using audio input, a user dynamically selects one or more modes of avatar body expression. For instance, the live audio stream 301 may be captured by a microphone on an HMD or other electronic device 101, such as based on an utterance by the user of the electronic device 101.

The live audio stream 301 is interpreted to request either head-only gesture generation 302 or head and body gesture generation 303. When head and body gesture generation 303 is elected, further selection between upper-body only gesture generation 304, full-body gesture generation 305, and full-body and finger gesture generation 306 can be performed. With full-body and finger gesture generation 306, active or static finger gestures 307 can be blended based on wrist position.

Although FIG. 3 illustrates one example of a dynamic selection process 300 by a user among modes of avatar body expressions for purposes of real-time gesture generation, various changes may be made to FIG. 3. For example, while depicted separately, full-body gesture generation 305 and full-body and finger gesture generation 306 may be performed in an overlapping manner, or static finger gestures 307 may be generated entirely separately from full-body gesture generation. Also, finger gesture generation 306 may be combined with head-only gesture generation 302 in appropriate circumstances. In addition, the specific modes shown here are examples only and can vary as needed or desired.

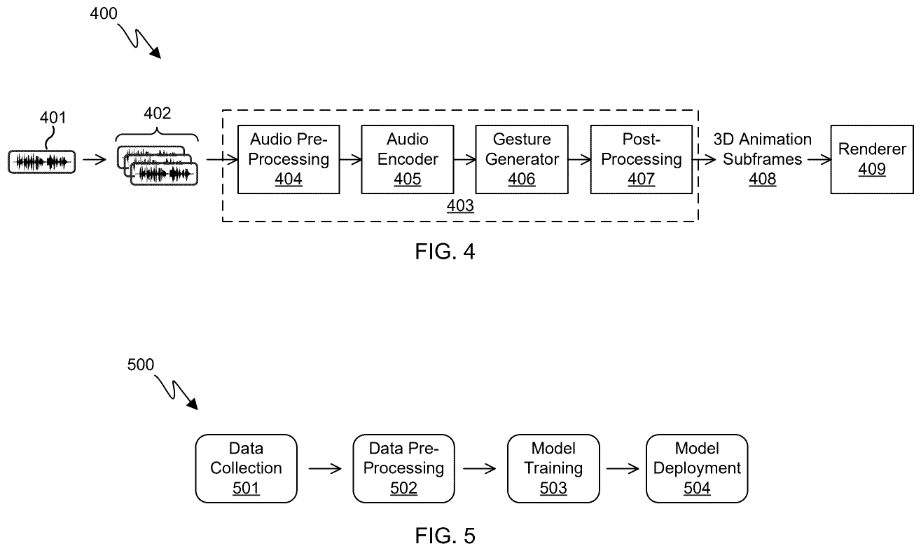

FIG. 4 illustrates an example architecture 400 for providing real-time audio-based gesture generation in accordance with this disclosure. For ease of explanation, the architecture 400 of FIG. 4 is described as being implemented using the electronic device 101 in the network configuration 100 of FIG. 1. However, the architecture 400 may be implemented using any other suitable device(s) and in any other suitable system(s).

As shown in FIG. 4, the architecture 400 can receive a live audio stream 401. The live audio stream 401 can be analogous to the live audio stream 301 of FIG. 3. The live audio stream 401 is buffered by audio buffers 402. Each of the audio buffers 402 has a fixed length, such as 120 milliseconds (ms). Portions of the audio in the audio buffers 402 are received by gesture generation 403 at audio pre-processing 404. In some cases, the audio pre-processing 404 processes animation-frame-length segments of currently-buffered audio and provides past and future audio content.

The audio segments provided by the audio pre-processing 404 are received by an audio encoder 405. The audio encoder 405 extracts speech features from the input audio waveform and adjusts audio sampling to match with the animation frame rate. In some cases, the speech features extracted by the audio encoder 405 may include mel frequency cepstral coefficients (MFCCs) and prosodic features, such as speech intensity and derivatives thereof. Also, in some cases, in extracting the speech features, a waveform window size may be set to 25 ms, and a frame stride can be calculated as (in ms): 1000/[N*animation frames per second (fps)], where N specifies how many times one animation frame is sliced.

The output of the audio encoder 405 is provided to a gesture generator 406, which in some cases may be a deep neural network (DNN) or other ML model that predicts a 3D representation of orientation for an avatar's upper body joints from input speech features. The input speech represented by the audio segment information received from the audio encoder 405 can be processed to include audio context information. For every animation frame, the model may be trained by providing speech features of α frames prior to and β frames following those of the current frame. In some cases, for example, α=30 and β=5. The output of the gesture generator 406 can include keyframes for the desired animation.

The animation keyframes from the gesture generator 406 are smoothed by post-processing 407, which in some cases can set an acceptable motion range to avoid jerkiness and unnatural poses, blend post-processing upper body motions with predetermined lower body and finger animations, and generate 3D animation subframes 408. The 3D animation subframes 408 are used by a renderer 409 to produce avatar animation, which may be employed in video content and synchronized with the input speech.

Although FIG. 4 illustrates one example of an architecture 400 for providing real-time audio-based gesture generation, various changes may be made to FIG. 4. For example, various components in FIG. 4 may be combined, further subdivided, replicated, omitted, or rearranged and additional components may be added according to particular needs.

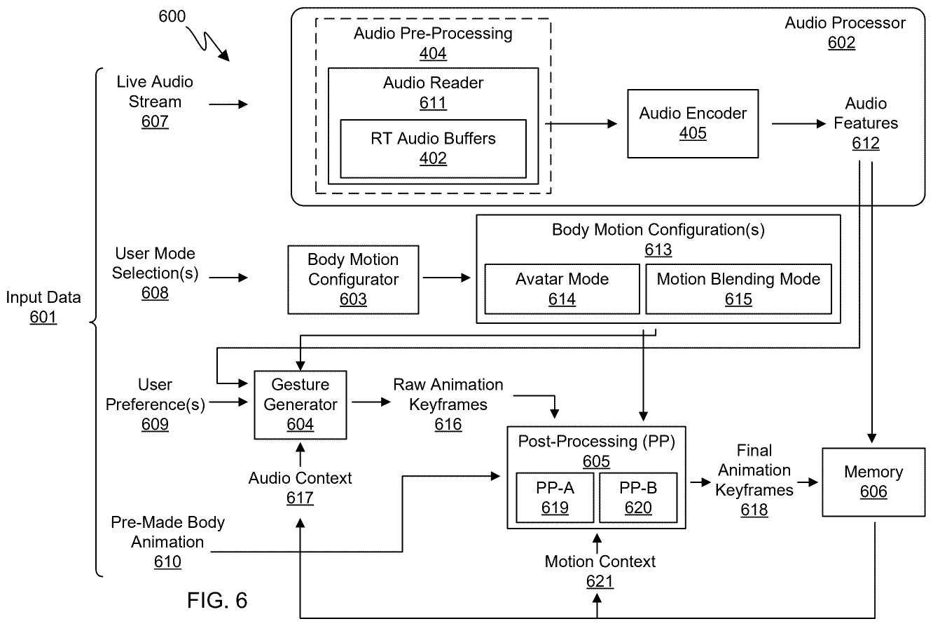

FIG. 5 illustrates an example model preparation system 500 for an AI-based model providing real-time audio-based gesture generation in accordance with this disclosure. For ease of explanation, the model preparation system 500 of FIG. 5 is described as being implemented using the electronic device 101 in the network configuration 100 of FIG. 1. However, the model preparation system 500 may be implemented using any other suitable device(s) (such as the server 106) and in any other suitable system(s).

As shown in FIG. 5, the model preparation system 500 includes data collection 501. Training data for model preparation can include motion data associated with speech from which 3D coordinates of a speaker's body joints associated with speech clips can be extracted. In some cases, the training data can be collected from at least one public dataset of videos. The training data also includes audio data, which can be used to generate corresponding audio files (such as Waveform Audio File Format or *.wav files) for each speech clip. Collecting the training data may also include collecting non-speech parts of audio from the public speech dataset(s) or other dataset(s), which can be paired with idle poses so that the model learns to predict more static body poses during pauses between periods of speech. The model preparation system 500 also includes data pre-processing 502, within which body orientation is estimated from the 3D coordinates derived as described above, and retargeted to the augmented reality (AR) avatar body hierarchy (such as within BVH format data as described in further detail below). Data pre-processing 502 can also include smoothing any noise in the collected data.

The model preparation system 500 further includes model training 503. In some cases, a long-short term memory (LSTM) encoder-decoder network may be employed to process sequential data within the training data and capture temporal dependencies within speaker motion. In some embodiments, the model may be developed using a software library (such as TensorFlow or PyTorch) and a suitable programming language (such as Python). Tuning hyper-parameters may be performed during model training 503 and may include adjusting characteristics like the number of layers, layer sizes, batch size, and/or dropout rate.

The model preparation system 500 still further includes model deployment 504. Through model deployment 504, models developed to run on personal computer (PC) resources or other devices can be converted into lightweight models and quantized for performance optimization. This may support, for example, deployment to mobile devices like smartphones. In some cases, conversion to a lightweight model may involve use of TensorFlow Lite (TF Lite, a/k/a LiteRT). An optimized lightweight model may be integrated into real-time avatar generation program(s).

As part of model optimization during model deployment 504, the gesture generation model may be optimized for real-time processing by incorporating an efficient architecture with precisely-chosen layers and an ideal number of hidden units, a reduced input data size through optimized feature selection, batching and windowing techniques to handle smaller sequential elements, and quantization/compression techniques that preserve animation quality. To confirm that the model maintains quality when made more lightweight, quantitative metrics measuring errors against ground truth animations may be employed. For example, the model's size and complexity may be successfully reduced without exceeding one or more acceptable error thresholds. The model may maintain high quality when converted from one version to another version and then quantized to lower bits with no significant degradation.

Although FIG. 5 illustrates one example of a model preparation system 500 for an AI-based model providing real-time audio-based gesture generation, various changes may be made to FIG. 5. For example, various components in FIG. 5 may be combined, further subdivided, replicated, omitted, or rearranged and additional components may be added according to particular needs. Also, training data for ML models may be obtained in any other suitable manner, and ML models may be trained in any other suitable manner.

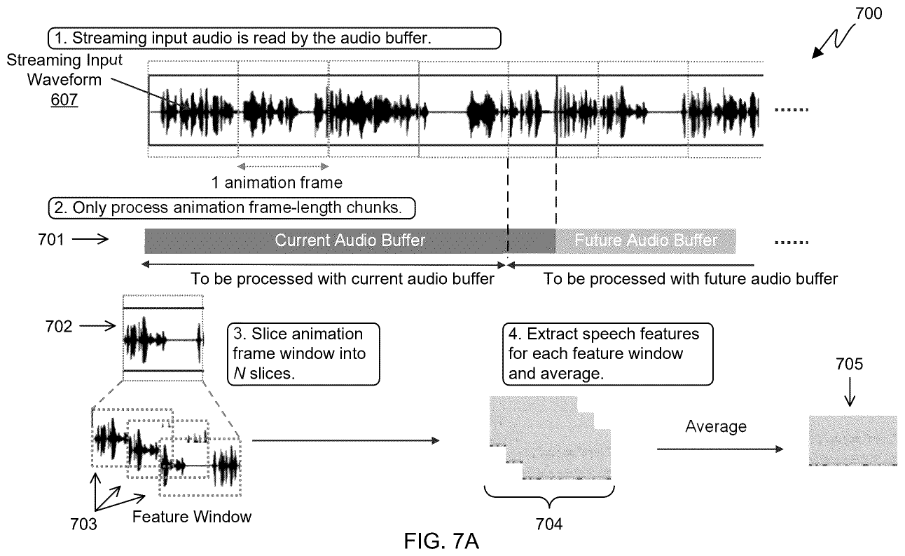

FIG. 6 illustrates an example pipeline 600 for AI-based provision of real-time audio-based full-body gesture generation in accordance with this disclosure. For ease of explanation, the pipeline 600 of FIG. 6 is described as being implemented using the electronic device 101 in the network configuration 100 of FIG. 1. However, the pipeline 600 may be implemented using any other suitable device(s) (such as the server 106) and in any other suitable system(s).

As shown in FIG. 6, the pipeline 600 employs input data 601, an audio processor 602, a body motion configurator 603, a gesture generator 604, a post-processing module 605, and memory 606. In some embodiments, there may be multiple kinds of input data 601, such as a live audio stream 607 from a user, user mode selection(s) 608, user preference(s) 609 for animation style, and predetermined body animation(s) 610.

The audio processor 602 receives a live audio stream 607 as an input, reads the audio waveform using an audio reader 611, and continuously accumulates the audio data into audio buffers 402. In some cases, each audio buffer 402 may hold 120 ms to 240 ms of audio. Once one of the audio buffers 402 is filled, the audio encoder 405 extracts audio features 612 (such as MFCCs, pitch and amplitude, etc.) from a current one of the audio buffers 402.

The body motion configurator 603 configures input body motion configuration(s) 613 based at least in part on the user mode selection(s) 608. In some cases, the user mode selection(s) 608 may allow the user to select from among (i) avatar mode 614, which may include head-only or head and body (where head and body may include upper-body only, full-body, or full-body and finger) and (ii) body motion blending mode 615, which may indicate whether to dynamically blend ML-driven results with predetermined animations (such as ML prediction of head motion blended with predetermined body expression of different emotions; ML prediction of body position and upper body gesture blended with predetermined lower-body walking animation, etc.) or to use fully ML-driven results.

The gesture generator 604 predicts raw 3D animation keyframes 616 for the body motion configuration(s) 613 using, as input, audio features 612 for the current one of the audio buffers 402 and audio context 617 for prior audio buffer(s) from memory 606. The raw 3D animation keyframes 616 produced by the gesture generator 604 may be further conditioned on other input, such as the user preference(s) 609 of animation style by which the user can specify the desired motion intensity (range and speed) of output gestures.

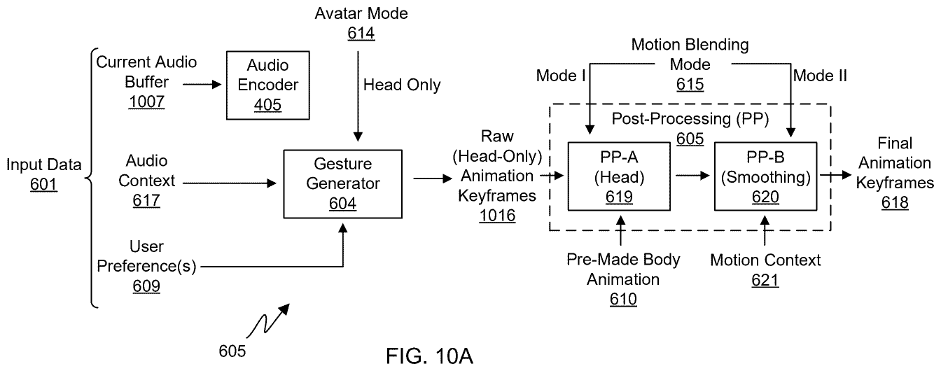

The post-processing module 605 takes the raw 3D animation keyframes 616 predicted by the gesture generator 604 and outputs final 3D animation keyframes 618. The post-processing module 605 may be configured by one or both of the avatar mode 614 and the body motion blending mode 615, which can be input to the post-processing module 605. Post-processing may be logically segregated into two categories (such as “A” and “B” below) depending upon the degree of ML-driven animation selected by the user. For example, if fully ML-driven mode is selected as the body motion blending mode 615, a PP-A module 619 within the post-processing module 605 is skipped, and a PP-B module 620 smooths animation using the animation keyframes of prior buffers as motion context 621 and corrects any sliding feet artifacts. If the user chooses to dynamically blend ML-driven results with predetermined animations, both the PP-A module 619 and the PP-B module 620 can be enabled. The PP-A module 619 synchronizes the motion intensity of both the ML-driven results and the predetermined body animations with the input audio (the portion of the live audio stream 607 from the current one of the audio buffers 402) and predicted body position, blending full-body post-processed animation keyframes. The PP-B module 620 subsequently performs animation smoothing and feet correction. Operations of the PP-A 619 and PP-B 620 are described in further detail below in connection with FIGS. 10A through 10C.

The generated final 3D animation keyframes 618 corresponding to the current one of the audio buffers 402, along with audio features 612 of that current buffer, can be stored in the memory 606 as motion context 621 and audio context 617, respectively. In some cases, such context information may be stored for a fixed number of recent buffers in a temporary in-memory structure and can be continuously updated to maintain context while keeping the file size constant.

Although FIG. 6 illustrates one example of a pipeline 600 for AI-based provision of real-time audio-based gesture generation, various changes may be made to FIG. 6. For example, various components in FIG. 6 may be combined, further subdivided, replicated, omitted, or rearranged and additional components may be added according to particular needs.

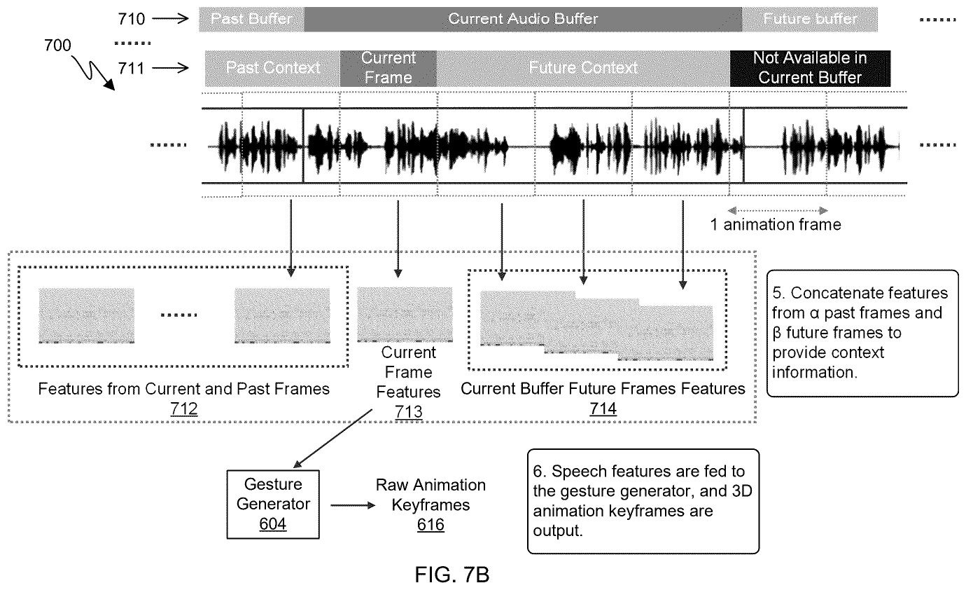

FIGS. 7A and 7B illustrate an example processing 700 of audio buffers of any length in real-time audio buffers of any length during AI-based provision of real-time audio-based gesture generation in accordance with this disclosure. For ease of explanation, the processing 700 in FIGS. 7A and 7B is described as being performed using the pipeline 600 of FIG. 6. However, the processing 700 may be performed using any other suitable pipeline(s) in any suitable device(s) and in any suitable system(s).

As shown in FIGS. 7A and 7B, the live audio stream 607 is read into audio buffers (such as audio buffers 402 in FIGS. 4 and 6). In FIG. 7A, the start of the live audio stream 607 is assumed to correspond to the start of buffered audio in a current audio buffer 701. However, in some cases, the content of the current audio buffer may be processed in animation frame-length chunks (segments corresponding to one animation frame as shown). The audio buffers need not be an integer multiple (in time duration) of one animation frame but can be of any length. Accordingly, a portion of the content of the current audio buffer having a duration less than one (full) animation frame may be processed with a subsequent future audio buffer.

The portion of content 702 for the current animation frame window in the current audio buffer 701 is sliced into N slices 703. For example, in some embodiments, N=3, and the slicing creates 25 ms slices 703 for each animation frame window. For each of the N slices (which includes a feature window), speech features 704 can be extracted and processed (such as averaged) to determine representative features 705.

FIG. 7B illustrates the same processing 700 as in FIG. 7A but at a time subsequent to that illustrated in FIG. 7A. As stated above, each of the audio buffers 710 may span a non-integer number of animation frames. However, context 711 (such as audio context 617 and motion context 621 of FIG. 6) does align with the animation frames. Representative features for α past animation frames and β future animation frames (that are available from the current audio buffer) may be concatenated or otherwise combined to provide the context information (audio context 617 and motion context 621). For example, the α past animation frames may be used to form past context, and the β future animation frames may be used to form future context. In some embodiments, α=30 and β=5. If the number of available animation frames is less that α or β, features for silent audio frames may be concatenated or otherwise combined with the features for available frames.

In this example, three groupings may be formed for context information: speech features 712 from the current animation frame and the α past animation frames; speech features 713 from the current animation frame; and speech features 714 from the β future animation frames that are available for the current audio buffer. These speech features 712, 713, and 714 can be fed to the gesture generator 604, and 3D animation keyframes 616 are output.

Although FIGS. 7A and 7B illustrate one example of processing 700 of audio buffers of any length in real-time audio buffers of any length during AI-based provision of real-time audio-based gesture generation, various changes may be made to FIGS. 7A and 7B. For example, any other suitable values may be used for the duration of each animation frame and of each audio buffer or for the number(s) N, α, and β.

In some embodiments of this disclosure, a conditional encoder-decoder model may be employed, where a pose encoder takes both animation keyframes and condition (hand position and velocity) so that users can control an output gesture style. During training, a style encoder may be used to provide conditions corresponding to training set animation data.

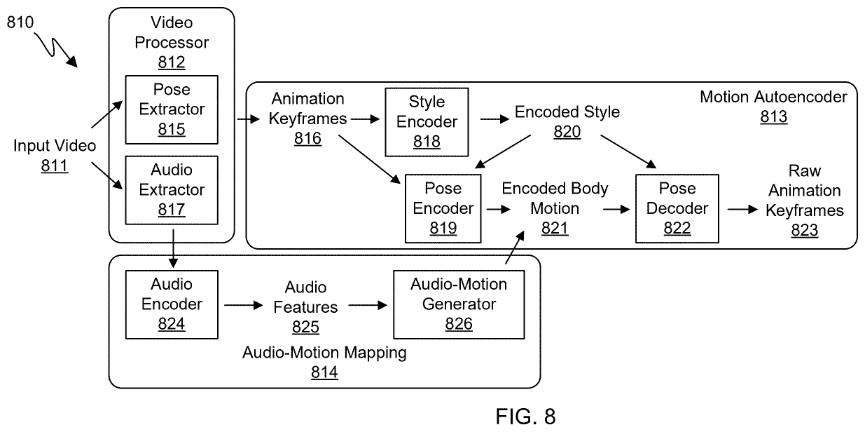

FIG. 8 illustrates example motion autoencoder training and audio-motion mapping for AI-based provision of real-time audio-based gesture generation in accordance with this disclosure. For ease of explanation, the training and mapping are described as being implemented for use with the pipeline 600 of FIG. 6. However, the training and mapping may be implemented for use with any other suitable pipeline(s) in any suitable device(s) and in any suitable system(s).

FIG. 8 illustrates combined motion autoencoder training and audio-motion mapping 810 in accordance with this disclosure. The pipeline illustrated for combined motion autoencoder training and audio-motion mapping 810 includes an input video 811 of human speech, a video processor 812, a motion autoencoder 813, and an audio-motion mapping module 814. The video processor 812 extracts human poses and audio elements from the input video 811. For example, a pose extractor 815 can identify joint locations of a speaker's body, capture three degree of freedom (3DoF) poses of each joint, and convert this data into 3D animation keyframes 816 (which may be formatted for biovision (BVH) compatibility). Simultaneously, an audio extractor 817 can isolate an audio waveform from the video 811.

The motion autoencoder 813 is designed to learn a comprehensive representation of human motion, incorporating style information derived from the extracted 3D animation keyframes 816. The motion autoencoder 813 can include two encoders, namely a style encoder 818 and a pose encoder 819. The style encoder 818, such as one implemented as a DNN or other ML model, can analyze velocities and positions of key upper and lower body joints, encoding that information into an encoded style 820. The pose encoder 819, such as one implemented as a DNN or other ML model, can compress the animation keyframes 816 into a more compact form that highlights essential motion features while reducing or minimizing noise. The pose encoder 819, such as one implemented as a DNN or other ML model, can integrate the encoded style 820 to enrich the encoded body motion 821. A pose decoder 822, such as one implemented as another DNN or other ML model, reconstructs the animation keyframes 823 from the compressed encoded body motion 821, which can involve using the encoded style 820 to ensure that the reconstructed motion retrains the intended style nuances.

The audio-motion mapping module 814 translates audio features into motion representation. For example, an audio encoder 824 can extract audio features 825 from the audio received from the audio extractor 817, such as MFCCs and/or pitch and amplitude. An audio-motion generator 826, such as one implemented as a DNN with recurrent layers or other ML model, can learn to map these audio features 825 to the encoded body motion 821 produced by the pose encoder 819.

Although FIG. 8 illustrates example motion autoencoder training and audio-motion mapping for AI-based provision of real-time audio-based gesture generation, various changes may be made to FIG. 8. For example, an encoded style may be taken into account during audio-motion mapping in FIG. 8.

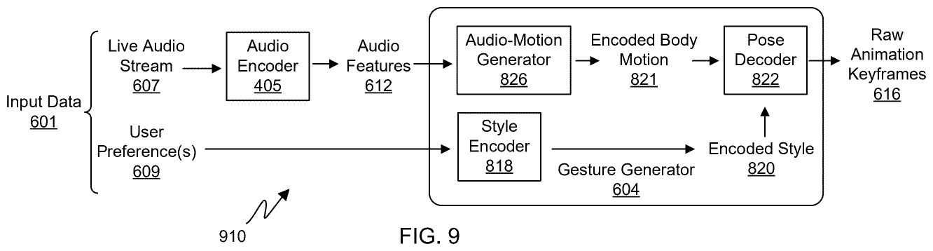

FIG. 9 illustrates example model inferencing for AI-based provision of real-time audio-based gesture generation in accordance with this disclosure. For ease of explanation, the model inferencing is described as being performed with the pipeline 600 of FIG. 6. However, the model inferencing may be performed with any other suitable pipeline(s) in any suitable device(s) and in any suitable system(s).

FIG. 9 illustrates model inferencing 910 in accordance with this disclosure. Here, FIG. 9 details the restructured pipeline of the combined motion autoencoder training and audio-motion mapping 810 for inferencing. The model inferencing 910 includes input data 601, audio encoder 405, and gesture generator 604. The input data 601 includes a live audio stream 607 (such as the user's voice captured via a microphone) and the specified user preference(s) 609 for animation style, which can determine the range and speed of gestures.

The audio encoder 405 processes the streaming audio to extract audio features 612, which are fed into the gesture generator 604. The audio-motion generator 826 takes the audio features 612 and produces encoded body motion 821. Concurrently, the user preference(s) 609 for animation style can be processed by the style encoder 818, converting the user preference(s) 609 into an encoded style 820. The pose decoder 822, conditioned by the encoded style 820, takes the encoded body motion 821 as input and generates the raw animation keyframes 616 to be processed in the subsequent post-processing module. Conditioning gesture generation with the encoded style 820 ensures that the pose decoder 822 tailors the output to match the user's desired style and delivers gestures consistent with the specified range and speed.

Although FIG. 9 illustrates model inferencing for AI-based provision of real-time audio-based gesture generation, various changes may be made to FIG. 9. For example, the audio context and/or the motion context may also be taken into account by the gesture generator in FIG. 9.

FIGS. 10A through 10C illustrate example post-processing for different modes of body expression during AI-based provision of real-time audio-based gesture generation in accordance with this disclosure. In particular, FIG. 10A depicts operation of the PP-A 619 and PP-B 620 for a first avatar mode (head-only animation), FIG. 10B depicts the operation of the PP-A 619 within FIG. 10A for the first avatar mode (head-only animation) in greater detail, and FIG. 10C depicts operation of the PP-A 619 and PP-B 620 for a second avatar mode (head and body animation). For ease of explanation, the post-processing of FIGS. 10A through 10C is described as being performed by the pipeline 600 of FIG. 6. However, the post-processing may be performed with any other suitable pipeline(s) in any suitable device(s) and in any suitable system(s).

In the first avatar mode (head-only but optionally with subtle body movement), the post-processing module 605 takes raw (head-only) animation keyframes 1016 (analogous to raw animation keyframes 616) predicted by the gesture generator 604 based on the content of the current audio buffer 1017 (a part of live audio stream 617) as an input. For different motion blending mode 615 from the body motion configuration 613, the following may be performed.

“Mode I” of the motion blending mode 615 may be employed if the user chooses to dynamically blend ML results for raw (head-only) animation keyframes 1016 with predetermined body animation 610, in which case both the PP-A 619 and the PP-B 620 are enabled. Head motion control 1014 (a subpart of avatar mode 614) allows the user to select modes of rotation constraints 1001 to apply weights to rotation about each axis. The rotation constraints 1001 can result in creating head orientation/motion 1002 that is any one of one-dimensional (1D) head motions (such as nodding, turning, or tilting), two-dimensional (2D) head motions (such as nodding and turning), or full 3D head motions. The body motion control 1015 (a subpart of the avatar mode 614) allows the user to select the operational modes of a body motion composer 1003 to blend predetermined body animation 610 of different emotions (such as happy, sad, surprise, etc.). The body motion composer 1003 can select body movement animation keyframes 1004 (excluding head movement) from predetermined body animation 610. In some cases, a mode can be provided where the body motion composer 1003 generates subtle body movements in sync with the head motion, such as by translating head motion into body position shifts along the XZ plane (side to side and back and forth). An animation blender 1005 combines post-processed head orientation/motion 1002 and body movement animation keyframes 1004 and outputs the full-body, raw, blended animation keyframes 1006. The PP-B 620 smooths the final animation keyframes 618 using the animation keyframes of prior buffers as motion context 621 and corrects any sliding feet artifacts. “Mode II” of the motion blending mode 615 may be employed if the user chooses full ML-driven results, in which case only the PP-B 620 is enabled. The first avatar mode may result in any of no head motion (such as based on rotation constraints 1001); 1D/2D/3D head motion with or without subtle body movement; or full 3D head motion and subtle body movement depending on sub-modes according to user mode selection(s) 608.

In the second avatar mode (head and body), the user can choose to dynamically blend ML results and predetermined animation. The post-processing module 605 (PP-A 619 and PP-B 620 combined) can take raw upper-body animation keyframes 1017 (analogous to raw animation keyframes 616) and body position 1007, both predicted by the gesture generator 604 based on the content of the current audio buffer 1017 (a part of live audio stream 617), as input. For different motion blending mode 615 from the body motion configuration 613, the following may be performed.

“Mode I” of the motion blending mode 615 may be employed if the user chooses to dynamically blend ML results (raw upper-body animation keyframes 1017 and body position 1007) and predetermined body animation 610, in which case both the PP-A 619 and the PP-B 620 are enabled. With the body motion control 1015 (a subpart of avatar mode 614), the user may select full-body or full-body and finger. In this example, for full-body animation, the user may select a first sub-mode [a] in which predetermined body animation 610 includes lower body walking motion generated in synchronization with the predicted body position 1007 or a second sub-mode [b] in which predetermined body animation 610 includes a selection from predetermined locomotive lower body motions with different emotions. For full-body and finger animation, all functionalities associated with full-body animation may be provided. In addition, different predetermined finger gesture animations from the predetermined body animation 610 may be blended with ML results (raw upper-body animation keyframes 1017 and body position 1007).

For synchronizing the predetermined body animation 610 with ML results (raw upper-body animation keyframes 1017 and body position 1007), a configuration writer 1008 creates configuration files 1009, such as based on input audio features 612 (generated by audio encoder 405 based on current audio buffer 1017 input) and positions and velocities of key upper-body joints 1010 (estimated by the joint estimator 1011 from raw upper-body keyframes 1017 and body position 1007 predicted by gesture generator 604). The configuration writer 1008 annotates animation keyframes with the speech pitch/amplitude and upper-body gesture activity level. A motion intensity synchronizer 1012 takes the configuration file 1009 and predetermined body animation 610 as inputs and outputs adjusted lower-body and finger keyframes. The animation blender 1013 combine raw upper-body animation keyframes 1017 and adjusted lower-body and finger animation keyframes from the motion intensity synchronizer 1012, producing the blended full-body animation keyframes 1006.

The PP-B 620 includes an animation smoother 1018 that smooths the blended animation keyframes 1006 using the animation keyframes of prior buffers as motion context 621 and employs feet correction 1019 to correct any sliding feet artifacts to create final animation keyframes 618. The PP-B 620 outputs the full-body final animation keyframes 618, which can be ready for presentation to the user.

“Mode II” of the motion blending mode 615 may be employed if the user chooses full ML-driven results, in which case only the PP-B 620 is enabled.

Although FIGS. 10A through 10C illustrate one example of post-processing for different modes of body expression during AI-based provision of real-time audio-based gesture generation, various changes may be made to FIGS. 10A through 10C. For example, the audio context may also be taken into account by the post-processing. Also, the specific modes and types described above are for illustration and explanation only.

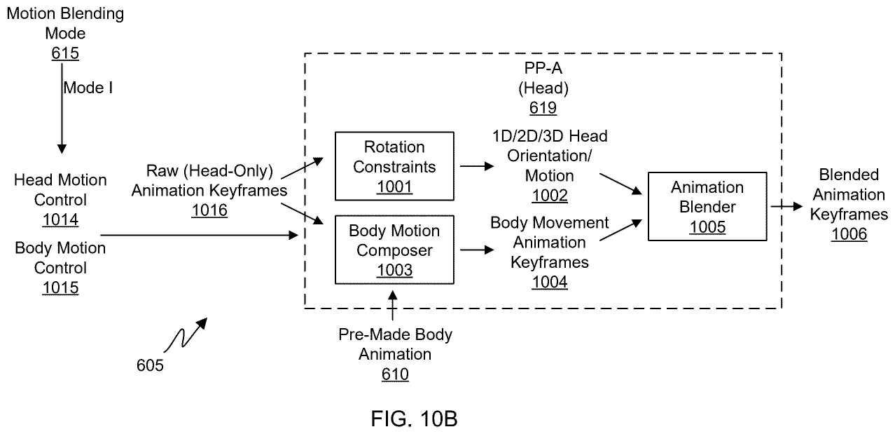

FIG. 11 illustrates example operation 1100 of the motion intensity synchronizer 1012 of FIG. 10C for lower body motion in accordance with this disclosure. For sub-mode [a] or sub-mode [b] of the Mode I motion blending (among the motion blending mode 615), the motion intensity of the predetermined body animation 610 can be set by parameters in the configuration files 1009. For parameters indicating a first motion intensity, the motion intensity synchronizer 1012 may simulate a smooth walking motion by blending a predetermined body animation 610 to match the predicted body position 1007, ensuring the seamless transitions and natural movement. For parameters indicating a second motion intensity, the user can select from predetermined locomotive lower body motions with different emotions (such as confident, happy, sad, etc.). The animation start time may be randomly selected for greater variability.

To make predetermined body animation 610 synchronize with audio features 612, the motion intensity synchronizer 1012 may perform following. The motion intensity synchronizer 1012 can smooth the input audio intensity. When the audio intensity falls below a threshold, the motion intensity synchronizer 1012 can pause the lower body animation as soon as both of the avatar's feet touch the ground. The motion intensity synchronizer 1012 can resume the animation once the audio intensity again exceeds the threshold.

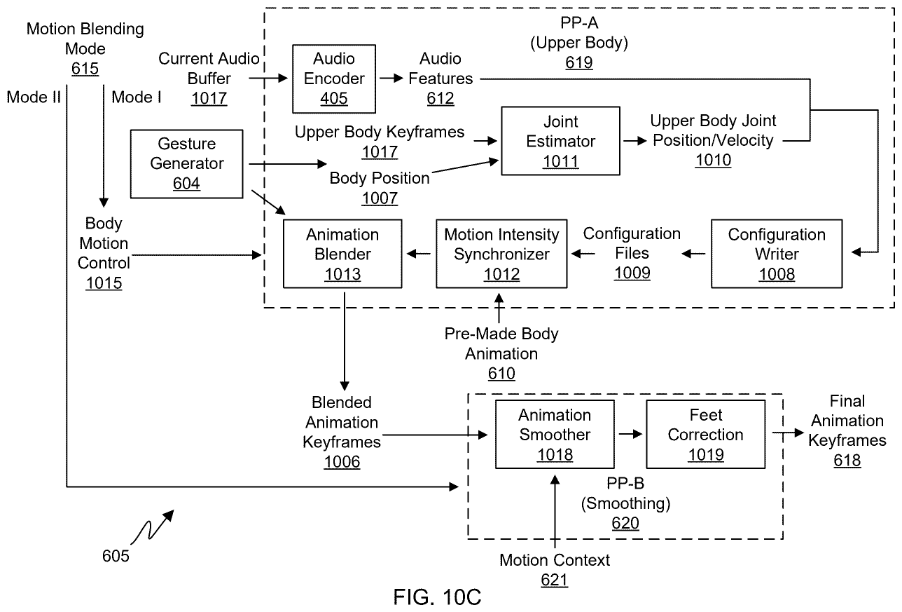

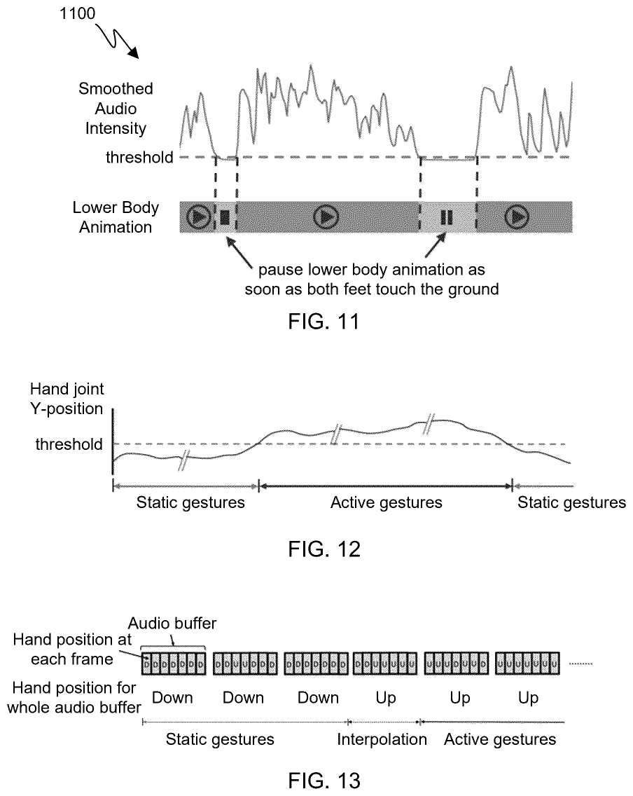

FIGS. 12 and 13 illustrate example operation of the motion intensity synchronizer 1012 of FIG. 10C for finger motion in accordance with this disclosure. The gesture generator 604 can predict the upper body keyframes 1017, and the joint estimator 1011 can calculate the height (Y-position) of a hand joint at each frame. As shown in FIGS. 12 and 13, the motion intensity synchronizer 1012 can blend a static finger gesture when the avatar's hands are down (D) and blends an active finger gesture when the avatar's hands are up (U).

Predetermined finger gestures with the predetermined body animation 610 may be labeled as either “static” or “active” based on the level of activity reflected. The motion intensity synchronizer 1012 can blend static finger gesture keyframes to the ML output for the positions and velocities of the key upper-body joints 1010 when the hand joint is below a certain height threshold. The motion intensity synchronizer 1012 can also blend active finger gestures to positions and velocities of the key upper-body joints 1010 above that threshold.

In some embodiments, each audio buffer may have a length of 120 ms and include seven animation frames, and the hand position for each frame may be either down (D) or up (U). The hand position for the whole audio buffer may be based on the majority of frame hand positions for that buffer. In a real-time solution, for each audio buffer, the motion intensity synchronizer 1012 can determine whether the hand position is below the threshold or not, and an interpolation may be applied between active and static gestures.

Although FIGS. 11 through 13 illustrate examples of the operations of the motion intensity synchronizer 1012 in FIG. 10C, various changes may be made to FIGS. 11 through 13. For example, the audio context may also be taken into account by the motion intensity synchronizer 1012 to smooth movement transition for the avatar.

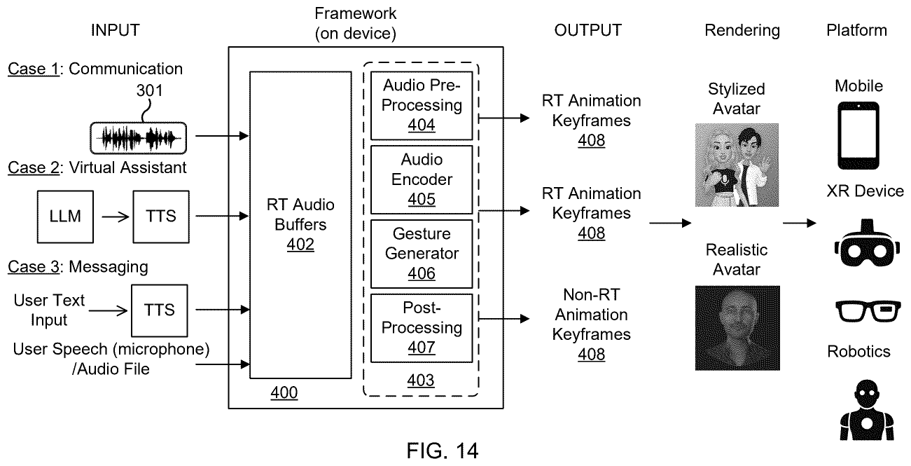

FIG. 14 illustrates example use cases for AI-based provision of real-time audio-based gesture generation in accordance with this disclosure. For ease of explanation, the use cases of FIG. 14 are described as being implemented using the architecture 400 shown in FIG. 4 for use with the electronic device 101 in the network configuration 100 of FIG. 1 operating in collaboration with the server 106. However, the use cases illustrated in FIG. 14 may be implemented using any other suitable architecture(s) in any suitable device(s) and/or suitable system(s). Also, the architecture 400 may be used with other use cases.

Case 1 in FIG. 14 involves communication, such as video teleconferencing, in which an AI avatar employed by a user or an on-device AI avatar for an XR device is used for conversation. Case 2 in FIG. 14 involves a visual (virtual) assistant in which the user interface for an AI large language model (LLM) presents as an avatar and receives voice input, responding with text-to-speech (TTS) output. Case 3 in FIG. 14 involves messaging, where an input may represent or include user-entered text, user speech (received in a microphone and converted using speech-to-text), or a pre-recorded audio file (also converted by speech-to-text). The message from any such input may be delivered (after TTS) via an avatar. For any of those three use cases, as illustrated in FIG. 14, the avatar may be either stylized or realistic, and the output platform may be a mobile terminal, an XR device, or a robotics device.

Although FIG. 14 illustrates examples of use cases for AI-based provision of real-time audio-based gesture generation, various changes may be made to FIG. 14. For example, other use cases may be used, including those involving variants of the three use cases depicted or combinations thereof.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method of generating three-dimensional (3D) avatar animation in real-time based on an audio stream, the method comprising:
buffering sequential portions of the audio stream within each of a plurality of audio buffers; and
for audio content in each of the plurality of audio buffers:
extracting speech features from the audio content in the audio buffer using an audio encoder;
providing the extracted speech features as an input to an on-device gesture generation model trained to predict 3D position of a body's center and orientation of all body joints in at least one of (i) only a head of a speaker or (ii) a head and body of the speaker;
based on the predicted 3D position of the body's center and orientation of all body joints, generating final 3D animation keyframes of gestures by an avatar for the speaker;
storing the extracted speech features and the final 3D animation keyframes of gestures by the avatar in at least one memory; and
playing audio corresponding to the audio content in the audio buffer and synchronously presenting the final 3D animation keyframes of gestures by the avatar to a viewer.

2. The method of claim 1, further comprising:
completing processing of the audio content in a specified one of the audio buffers before fully playing the audio corresponding to the audio content in a preceding one of the audio buffers and synchronously presenting the corresponding final 3D animation keyframes of the avatar to the viewer.

3. The method of claim 1, further comprising:
continuously updating extracted speech features and final 3D animation keyframes for a fixed number of the plurality of audio buffers stored to maintain a context; and
providing the extracted speech features from the at least one memory to the gesture generation model as context.

4. The method of claim 1, further comprising:
receiving an avatar mode selection from a user, wherein a first avatar mode corresponds to 3D avatar animation for only the head of the speaker and a second avatar mode corresponds to 3D avatar animation for the head and body of the speaker.

5. The method of claim 1, further comprising:
receiving a motion blending mode selection from a user, wherein:
(i) in a first motion blending mode, motion blending is enabled, with predicted raw animation keyframes blended with predetermined animations and
(ii) in a second motion blending mode, the predicted raw animation keyframes are directly used.

6. The method of claim 5, further comprising:
generating the 3D avatar animation in a first avatar mode, wherein the first motion blending mode comprises:
predicting raw head animation keyframes;
constraining rotation axes to control head motion types;
one of:
blending the raw head animation keyframes with predetermined body animation; or
applying body movement in synchronization with head motion for the 3D avatar animation for only an upper body; and
generating the 3D avatar animation in the first avatar mode, wherein the second motion blending mode comprises:
predicting the raw head animation keyframes; and
generating the 3D avatar animation in the second avatar mode, wherein the first motion blending mode comprises:
predicting raw upper body animation keyframes and body positions; and
blending the raw upper body animation keyframes with one of predetermined lower body animations, predetermined finger motions, or both predetermined lower body animations and predetermined finger motions in a synchronized manner that aligns with the predicted body positions; and
generating the 3D avatar animation in the second avatar mode and the second motion blending mode comprises:
one of:
predicting the raw upper body animation keyframes and body positions; or
predicting raw full body animation keyframes and body positions.

7. The method of claim 6, wherein blending the raw upper body animation keyframes with the predetermined lower body animations and finger motions comprises synchronizing motion intensity of the predetermined animation with pitch and intensity of the audio corresponding to the audio content in the audio buffer and with the predicted body positions.

8. The method of claim 7, wherein synchronizing the motion intensity of body animation with the pitch and intensity of the audio comprises:
creating at least one configuration file based on input audio features and predicted body keyframes;
setting parameters in the at least one configuration file controlling motion intensity of the predetermined lower body animations and selection of active or subtle finger gestures; and
combining the raw upper body animation keyframes with the predetermined lower body animations and finger motions according to the motion intensity and the selection of active or subtle finger gestures.

9. The method of claim 1, wherein the gesture generation model is configured to:
predict encoded avatar motion from the speech features;
receive the encoded avatar motion to generate raw 3D avatar animation keyframes; and
condition motion generation based on a gesture style input allowing user control over a style of hand motions.

10. The method of claim 1, wherein generating the final 3D animation keyframes of gestures by the avatar for the speaker comprises:
applying a smoothing filter across motion sequences including prior 3D animation keyframes from the at least one memory; and
correcting one or more sliding feet artifacts of a lower body of the avatar.

11. The method of claim 1, wherein the on-device gesture generation model is deployed on at least one of: a mobile device, an extended reality (XR) device, or a robot.

12. The method of claim 1, wherein the audio corresponding to the audio content in a specified one of the audio buffers is one of:
the audio content in the specified one of the audio buffers that is directly played for the viewer; or
audio generated by a text-to-speech model for the audio content in the specified one of the audio buffers.

13. An electronic device for generating three-dimensional (3D) avatar animation in real-time based on an audio stream, the electronic device comprising:
at least one processing device configured to:
buffer sequential portions of the audio stream within each of a plurality of audio buffers; and
for audio content in each of the plurality of audio buffers:
extract speech features from the audio content in the audio buffer using an audio encoder;
provide the extracted speech features as an input to an on-device gesture generation model trained to predict 3D position of a body's center and orientation of all body joints in at least one of (i) only a head of a speaker or (ii) a head and body of the speaker;
based on the predicted 3D position of the body's center and orientation of all body joints, generate final 3D animation keyframes of gestures by an avatar for the speaker;
store the extracted speech features and the final 3D animation keyframes of gestures by the avatar in at least one memory; and
play audio corresponding to the audio content in the audio buffer and synchronously present the final 3D animation keyframes of gestures by the avatar to a viewer.

14. The electronic device of claim 13, wherein the at least one processing device is further configured to complete processing of the audio content in a specified one of the audio buffers before fully playing the audio corresponding to the audio content in a preceding one of the audio buffers and synchronously presenting the corresponding final 3D animation keyframes of the avatar to the viewer.

15. The electronic device of claim 13, wherein the at least one processing device is further configured to:
continuously update extracted speech features and final 3D animation keyframes for a fixed number of the plurality of audio buffers stored to maintain a context; and
provide the extracted speech features from the at least one memory to the gesture generation model as context.

16. The electronic device of claim 13, wherein:
the at least one processing device is further configured to receive an avatar mode selection from a user, wherein a first avatar mode corresponds to 3D avatar animation for only the head of the speaker and a second avatar mode corresponds to 3D avatar animation for the head and body of the speaker.

17. The electronic device of claim 13, wherein the at least one processing device is further configured to receive a motion blending mode selection from a user, wherein
(i) in a first motion blending mode, motion blending is enabled, with predicted raw animation keyframes blended with predetermined animations and
(ii) in a second motion blending mode, the predicted raw animation keyframes are directly used.

18. The electronic device of claim 17, wherein:
to generate the 3D avatar animation in a first avatar mode and the first motion blending mode, the at least one processing device is configured to:
predict raw head animation keyframes; and
constrain rotation axes to control head motion types; and
one of:
blend the raw head animation keyframes with predetermined body animation; or
apply body movement in synchronization with head motion for the 3D avatar animation for only an upper body; and
to generate the 3D avatar animation in the first avatar mode and the second motion blending mode, the at least one processing device is configured to predict the raw head animation keyframes;
to generate the 3D avatar animation in a second avatar mode and the first motion blending mode, the at least one processing device is configured to:
predict raw upper body animation keyframes and body positions; and
blend the raw upper body animation keyframes with one of predetermined lower body animations, predetermined finger motions, or both predetermined lower body animations and predetermined finger motions in a synchronized manner that aligns with the predicted body positions; and
to generate the 3D avatar animation in the second avatar mode and the second motion blending mode, the at least one processing device is configured to one of:
predict the raw upper body animation keyframes and body positions; or
predict raw full body animation keyframes and body positions.

19. The electronic device of claim 18, wherein, to blend the raw upper body animation keyframes with the predetermined lower body animations and finger motions, the at least one processing device is configured to synchronize motion intensity of the predetermined animation with pitch and intensity of the audio corresponding to the audio content in the audio buffer and with the predicted body positions.

20. A non-transitory machine readable medium containing instructions that when executed cause at least one processor of an electronic device to:
buffer sequential portions of an audio stream within each of a plurality of audio buffers; and
for audio content in each of the plurality of audio buffers:
extract speech features from the audio content in the audio buffer using an audio encoder;
provide the extracted speech features as an input to an on-device gesture generation model trained to predict 3D position of a body's center and orientation of all body joints in at least one of (i) only ahead of a speaker or (ii) a head and body of the speaker;
based on the predicted 3D position of the body's center and orientation of all body joints, generate final 3D animation keyframes of gestures by an avatar for the speaker;
store the extracted speech features and the final 3D animation keyframes of gestures by the avatar in at least one memory; and
play audio corresponding to the audio content in the audio buffer and synchronously present the final 3D animation keyframes of gestures by the avatar to a viewer.
